(19) United States
(12) Patent Application Publication
(10) Pub. No.: US 2026/0029187 A1
(43) Pub. Date: Jan. 29, 2026

(54) PCM STEEL SHEET FOR HOME APPLIANCES AND REFRIGERATOR INCLUDING THE SAME

(71) Applicant: SAMSUNG ELECTRONICS CO., LTD., Suwon-si (KR)

(72) Inventors: Jungmin CHOI, Suwon-si (KR); Seok RHEE, Suwon-si (KR); Jihyun KIM, Suwon-si (KR); Choongkeon KIM, Suwon-si (KR); Joohyun JUNG, Suwon-si (KR); Youngdeog KOH, Suwon-si (KR); DOSOO SUNG, Suwon-si (KR)

(73) Assignee: SAMSUNG ELECTRONICS CO., LTD., Suwon-si (KR)

(21) Appl. No.: 19/170,981

(22) Filed: Apr. 4, 2025

Related U.S. Application Data
(63) Continuation of application No. PCT/KR2025/095002, filed on Mar. 20, 2025.

(30) Foreign Application Priority Data
Jul. 25, 2024 (KR) 10-2024-0098816

(51) Int. Cl. F25D 23/02; B05D 5/02; B05D 7/00; B05D 7/14

(52) U.S. Cl. CPC F25D 23/028; B05D 5/02; B05D 7/14; B05D 7/53; B05D 2202/10; B05D 2502/00; B05D 2503/00; B05D 2508/00

(57) ABSTRACT

A pre-coated metal (PCM) steel sheet for a home appliance may include: a steel sheet; a base coating layer on the steel sheet, the based coating layer including a matting agent and at least one of a melamine curing agent and an isocyanate curing agent; a print layer on the base coating layer; and a clear coating layer on the print layer, wherein the base coating layer may include up to 10 wt % of the matting agent based on a total weight of the base coating layer.

### CROSS-REFERENCE TO RELATED APPLICATIONS

This application is a continuation application of International Application No. PCT/KR2025/095002 designating the United States, filed on Mar. 20, 2025, in the Korean Intellectual Property Receiving Office, which claims priority from Korean Patent Application No. 10-2024-0098816, filed on Jul. 25, 2024, in the Korean Intellectual Property Office, the disclosures of which are hereby incorporated by reference herein in their entireties.

### BACKGROUND

### Field

Various embodiments of the disclosure relate to a pre-coated metal (PCM) steel sheet and a refrigerator including the same.

### Description of Related Art

Home appliances, such as refrigerators, may include a steel sheet for implementing the exterior. Pre-coated metal (PCM) steel sheets or vinyl-coated metal (VCM) steel sheets may be adopted as such steel sheets. To implement various patterns to suit the needs of consumers, it may be appropriate to use VCM steel sheets, which are high-gloss and high-distinctness steel sheets, instead of PCM steel sheets. However, use of VCM steel plates may increase the production costs.

### SUMMARY

Various embodiments of the disclosure may implement high gloss and high distinctness at the level of the VCM by adopting a digital printing method and adjusting the composition.

In accordance with the present disclosure, a pre-coated metal (PCM) steel sheet for a home appliance may include: a steel sheet; a base coating layer on the steel sheet, the base coating layer including a matting agent and at least one of a melamine curing agent and an isocyanate curing agent; a print layer on the base coating layer; and a clear coating layer on the print layer, wherein the base coating layer may include up to 10 wt % of the matting agent based on a total weight of the base coating layer.

The base coating layer may include 1 wt % to 20 wt % of the melamine curing agent based on the total weight of the base coating layer.

The base coating layer may include 1 wt % to 20 wt % of the isocyanate curing agent based on the total weight of the base coating layer.

The base coating layer may include 1 wt % to 3 wt % of the melamine curing agent based on the total weight of the base coating layer and 1 wt % to 3 wt % of the isocyanate curing agent based on the total weight of the base coating layer.

A surface tension of the base coating layer may be 30 dynes to 60 dynes.

The base coating layer may include up to 4 wt % of the matting agent based on the total weight of the base coating layer.

The print layer may be printed on the base coating layer based on a digital image.

A 20-degree gloss of the base coating layer may be 30 GU or more.

A 20-degree gloss of the clear coating layer may be 70 GU or more.

A distinctness of image (DOI) of the clear coating layer may be 70 or more.

In accordance with the present disclosure, a refrigerator may include: a main body; a storage compartment formed inside the main body; and a door rotatably coupled to the main body and configured to open to correspondingly open at least a portion of the storage compartment, the door may include a pre-coated (PCM) steel sheet that may include: a steel sheet, a base coating layer on the steel sheet, the base coating layer including a matting agent and at least one of a melamine curing agent and an isocyanate curing agent, a print layer on the base coating layer, and a clear coating layer on the print layer, wherein the base coating layer may include up to 10 wt % of the matting agent based on a total weight of the base coating layer.

The base coating layer may include 1 wt % to 20 wt % of the melamine curing agent based on the total weight of the base coating layer.

The base coating layer may include 1 wt % to 20 wt % of the isocyanate curing agent based on the total weight of the base coating layer.

The base coating layer may include 1 wt % to 3 wt % of the melamine curing agent based on the total weight of the base coating layer and 1 wt % to 3 wt % of the isocyanate curing agent based on the total weight of the base coating layer.

A surface tension of the base coating layer may be 30 dynes to 60 dynes.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

FIG. 1 is a perspective view illustrating a refrigerator according to an embodiment;

FIG. 2 is a perspective view illustrating a state in which doors of a refrigerator are opened according to an embodiment;

FIG. 3 is a view schematically illustrating a PCM steel sheet for home appliances according to an embodiment;

FIGS. 4 and 5 are graphs illustrating the relationship between the glossiness of a base coating layer and the glossiness of a clear coating layer in the PCM steel sheet of FIG. 3;

FIGS. 6 and 7 are graphs illustrating the glossiness and distinctness of image (DOI) of a clear coating layer according to the type of a curing agent and a proportion of a matting agent added in the PCM steel sheet of FIG. 3; and

FIG. 8 illustrates an experimental example for describing the distinctness of image of a print layer according to a proportion of a matting agent added to a base coating layer in the PCM steel sheet of FIG. 3.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

The term “and/or” may denote a combination(s) of a plurality of related components as listed or any of the components.

As used herein, such terms as “1st” and “2nd,” or “first” and “second” may be used to simply distinguish a corresponding component from another, and does not limit the components in other aspect (e.g., importance or order).

As used herein, the terms ‘front surface,’ ‘rear surface,’ ‘upper surface,’ ‘side surface,’ ‘left side,’ ‘right side,’ ‘upper portion,’ and ‘lower portion’ are defined with respect to the drawings, and the shape and position of each component are not limited by the terms.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The refrigerator according to an embodiment may include a main body.

The “main body” may include an inner case, an outer case disposed outside the inner case, and an insulator disposed between the inner case and the outer case.

The “inner case” may include at least one of a case, a plate, a panel, or a liner forming a storage compartment. The inner case may be formed as a single body or may be formed by assembling a plurality of plates. The “outer case” may form the outer appearance of the main body and may be coupled to an outer side of the inner case so that the insulator is disposed between the inner case and the outer case.

The “insulator” may insulate the inside of the storage compartment and the outside of the storage compartment so that the temperature inside the storage compartment is maintained at a set appropriate temperature without being affected by the environment outside the storage compartment. According to an embodiment, the insulator may include a foam insulator. The foam insulator may be formed by injecting and foaming a urethane foam formed by mixing polyurethane and a foaming agent between the inner case and the outer case.

According to an embodiment, the insulator may further include a vacuum insulator in addition to the foam insulator, or the insulator may be composed of only a vacuum insulator instead of the foam insulator. The vacuum insulation material may include a core material and an outer cover material that accommodates the core material and seals the inside at a pressure close to vacuum or vacuum. However, the insulator is not limited to the foam insulator or the vacuum insulator, and may include various materials that may be used for insulation.

The “storage compartment” may include a space limited by the inner case. The storage compartment may further include an inner case that limits a space corresponding to the storage compartment. Various items such as food, medicine, cosmetics, etc. may be stored in the storage compartment, and the storage compartment may be formed so that at least one side thereof is opened to take in and out the items.

The refrigerator may include one or more storage compartments. When two or more storage compartments are formed in the refrigerator, each storage compartment may have a different use and may be maintained at a different temperature. To that end, each storage compartment may be partitioned from each other by a partition wall including an insulator.

The storage compartment may be provided to be maintained in an appropriate temperature range according to the use, and may include a “refrigerating compartment”, a “freezing compartment”, or an “adjustable-temperature compartment” divided by the use and/or temperature range thereof. The refrigerating compartment may be maintained at a temperature suitable for refrigerating and storing items, and the freezing compartment may be maintained at a temperature suitable for freezing and storing items. The term “refrigerating” may mean cooling the item to the extent that the item is not frozen, and for example, the refrigerating compartment may be maintained in the range of 0 degrees Celsius to 7 degrees Celsius. The term “freezing” may mean cooling the item to freeze or remain frozen, and for example, the freezing compartment may be maintained in the range of minus 20 degrees Celsius to minus 1 degree Celsius. The adjustable-temperature compartment may be used as any one of the refrigerating compartment or the freezing compartment regardless of the user's selection.

The storage compartment may be referred to as a “vegetable compartment”, a “fresh compartment”, a “cooling compartment”, an “ice-making compartment”, and the like, in addition to the names “refrigerating compartment”, “freezing compartment”, and “adjustable-temperature compartment”, and the terms “refrigerating compartment”, “freezing compartment”, and “adjustable-temperature compartment” used below should be understood to collectively mean storage compartments having their respective corresponding uses and temperature ranges.

According to an embodiment, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front surface of the main body.

The “door” may be configured to seal the storage compartment when the door is closed. Like the main body, the door may include an insulator to insulate the storage compartment when the door is closed.

According to an embodiment, the door may include a door outer plate forming a front surface of the door, a door inner plate forming a rear surface of the door and facing the storage compartment, an upper cap, a lower cap, and a door insulator provided thereinside.

A gasket may be provided on the edge of the door inner plate to seal the storage compartment by being in close contact with the front surface of the main body when the door is closed. The door inner plate may include a dyke protruding rearward to mount a door basket capable of storing an object.

According to an embodiment, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulator provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to an embodiment, the refrigerator may include a cold air supply device configured to supply cold air to the storage compartment.

The “cold air supply device” may include a machine, an instrument, an electronic device, and/or a system combining the machine, the instrument, and the electronic device capable of generating cold air and guiding the cold air to cool the storage compartment.

According to an embodiment, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to an embodiment, the cold air supply device may include a semiconductor such as a thermoelectric element. The thermoelectric element may cool the storage compartment by heating and cooling through the Peltier effect.

According to an embodiment, the refrigerator may include a machine room in which at least some components belonging to the cold air supply device are arranged.

The “machine room” may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to an embodiment, the refrigerator may include a dispenser provided on the door to provide water and/or ice. The dispenser may be provided on the door to be accessed by the user without opening the door.

According to an embodiment, the refrigerator may include an ice maker provided to generate ice. The ice maker may include an ice making tray storing water, an ice maker separating ice from the ice making tray, and an ice bucket storing ice generated in the ice making tray.

According to an embodiment, the refrigerator may include a controller for controlling the refrigerator.

The “controller” may include a memory storing or recording a program and/or data for controlling the refrigerator, and a processor outputting a control signal for controlling the cold air supply device according to the program and/or data stored in the memory.

The memory stores or records various information, data, instructions, programs, etc. necessary for the operation of the refrigerator. The memory may store temporary data generated while generating a control signal for controlling components included in the refrigerator. The memory may include at least one of a volatile memory and a non-volatile memory or a combination thereof.

The processor controls the overall operation of the refrigerator. The processor may control the components of the refrigerator by executing a program stored in the memory. The processor may include a separate NPU that performs the operation of the artificial intelligence model. The processor may include a central processing unit, a graphics-only processor (GPU), and the like. The processor may generate a control signal for controlling the operation of the cold supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored/stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

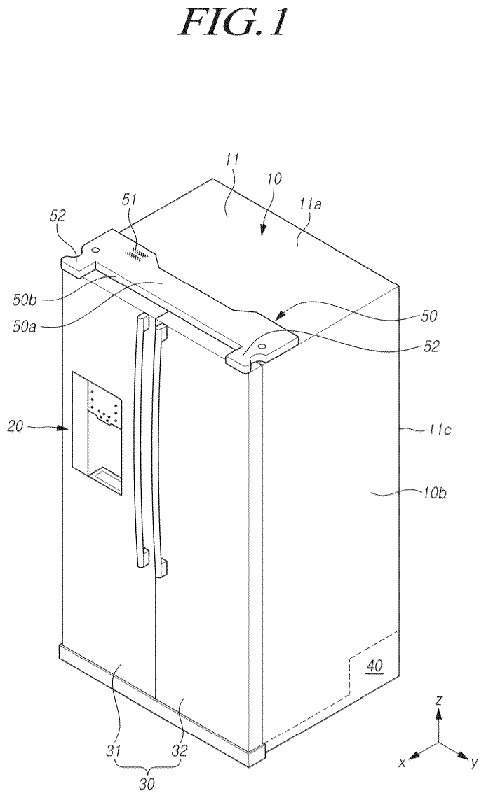

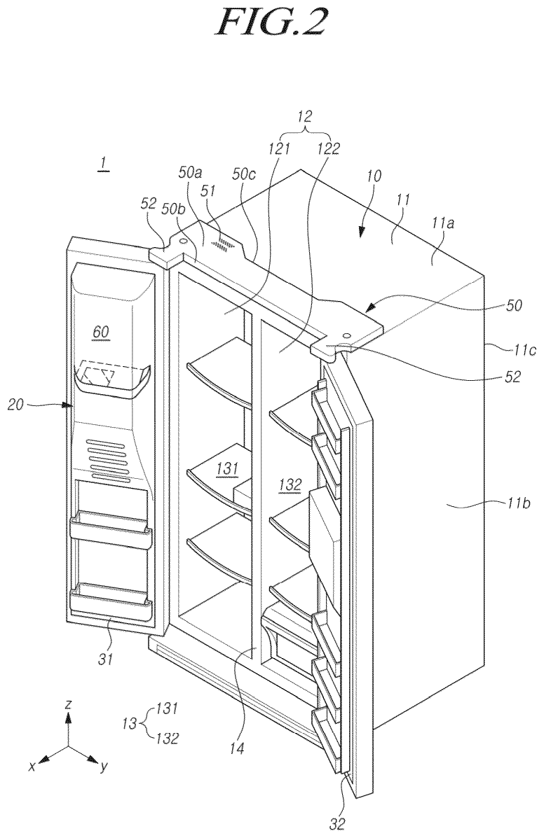

FIG. 1 is a perspective view illustrating a refrigerator according to an embodiment. FIG. 2 is a perspective view illustrating a state in which doors of a refrigerator are opened according to an embodiment.

The refrigerator shown in FIGS. 1 and 2 is a side-by-side type, but this is exemplary, and the scope of the disclosure is not limited to a side-by-side type refrigerator.

Referring to FIGS. 1 and 2, the refrigerator 1 may include at least one of a main body 10, a dispenser 20, a door 30, or a cover member 50.

According to an embodiment, the main body 10 may include an outer case 11 or an inner case 12. The inner case 12 may be configured to form an exterior of the storage compartment 13, for example. The inner case 12 may be configured to define a shape of the storage compartment 13. The inner case 12 may be integrally injection-molded with a plastic material, for example. The outer case 11 may be configured to form at least a portion of the exterior of the refrigerator 1, for example. The outer case 11 may be formed of, e.g., a metal material with excellent durability and finish, but is not limited thereto.

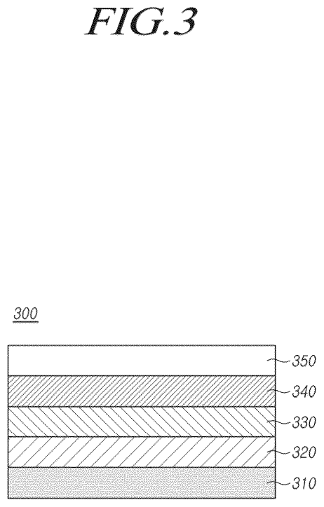

According to an embodiment, the outer case 11 may include a PCM steel sheet (e.g., the PCM steel sheet 300 of FIG. 3) to be described below.

According to an embodiment, the inner case 12 may include a PCM steel sheet (e.g., the PCM steel sheet 300 of FIG. 3) to be described below.

According to an embodiment, an accommodation space may be formed between the outer case 11 and the inner case 12. The main body 10 may include a foaming agent (or an insulator) for insulating the storage compartment 13. The foaming agent may fill the accommodation space between the outer case 11 and the inner case 12. A foaming agent (or an insulator) formed of an insulating material for insulating the storage compartment 13 may be formed in a portion of the accommodation space.

According to an example, the outer case 11 may include an upper surface 11a, a side surface 11b extending substantially perpendicular to the upper surface 11a and having an outer surface facing in the +y direction or the −y direction, and a rear surface 11c extending from the upper surface 11a and having an outer surface facing in the −x direction. The side surface 11b and the rear surface 11c may be disposed adjacent to each other. The side surface 11b and the rear surface 11c may be disposed to be substantially perpendicular to each other. The upper surface 11a, the side surface 11b, and the rear surface 11c may be integrally formed, but the disclosure is not limited thereto. Although not shown, the outer case 11 may include a lower surface facing the bottom surface.

According to an embodiment, the front side (e.g., +x direction) of the main body 10 may be open. A user may store food in the storage compartment 13 through the front side of the main body 10.

According to an embodiment, the main body 10 may include the storage compartment 13. The storage compartment 13 may be defined by the inner case 12. The storage compartment 13 may be a space formed to store food and refrigerate or freeze the food.

According to an embodiment, the storage compartment 13 may include a first storage compartment 131 or a second storage compartment 132. The number of storage compartments 13 may vary depending on the type of the refrigerator. The first storage compartment 131 and the second storage compartment 132 may be partitioned by a partition wall 14. The refrigerator 1 may include a partition wall 14 extending in a vertical direction (e.g., the z-axis direction). The first storage compartment 131 may be formed on one side of the partition wall 14 and the second storage compartment 132 may be formed on the other side of the partition wall 14. The sizes of the first storage compartment 131 and the second storage compartment 132 may vary according to the position of the partition wall 14. A space between the first storage compartment 131 and the second storage compartment 132 may be insulated by the partition wall 14. The shape and number of the partition walls 14 may be different depending on the type of the refrigerator 1.

According to an embodiment, one of the first storage compartment 131 and the second storage compartment 132 may be a refrigerating compartment and the other may be a freezing compartment. The temperature of the freezing compartment may be about between −18 and −23 degrees. The temperature of the refrigerating compartment may be between about 0 and 7 degrees. For example, the first storage compartment 131 may be a freezing compartment, and the second storage compartment 132 may be a refrigerating compartment, but the disclosure is not limited thereto.

According to an embodiment, the first storage compartment 131 may be configured to store food at a first temperature. According to an embodiment, the second storage compartment 132 may be configured to store food at a second temperature. The second temperature may be higher than the first temperature. The first temperature may be a temperature of about 18 degrees below zero to about 23 degrees below zero, but the range is not limited thereto. The second temperature may be a temperature between 0 and 7 degrees, but the range is not limited thereto. Hereinafter, a case where the first storage compartment 131 is a freezing compartment and the second storage compartment 132 is a refrigerating compartment is described as an example.

According to an embodiment, the front side (e.g., the +x direction) of the storage compartment 13 may be formed to be open. The front of the storage compartment 13 may be opened or closed by the door 30.

According to an embodiment, the door 30 may be configured to open and close the opening of the main body 10. The door 30 may be configured to open and close the storage compartment 13. The door 30 may be disposed in a double door type to open and close the first storage compartment 131 and the second storage compartment 132, but is not limited thereto. The door 30 may be configured to rotate around a hinge. The door 30 may be coupled to the main body 10 by a hinge to be rotatable about the main body 10. The refrigerator 1 may include a first hinge configured to rotatably couple the first door 31 to the main body 10. The refrigerator 1 may include a second hinge configured to rotatably couple the second door 32 to the main body 10.

According to an embodiment, the door 30 may include a first door 31 and a second door 32. The first door 31 may be disposed to open and close the first storage compartment 131. The second door 32 may be disposed to open and close the second storage compartment 132.

According to an embodiment, the door 30 may include a PCM steel sheet (e.g., the PCM steel sheet 300 of FIG. 3) to be described below.

According to an embodiment, the dispenser 20 may be configured to supply at least one of water or ice. The dispenser 20 may include a water dispensing space for taking water or ice by inserting a container such as a cup. The dispenser 20 may include an operation lever capable of operating water or ice to be discharged. The dispenser 20 may receive water from an external water supply source. For example, the dispenser 20 may receive water directly or indirectly from the water supply pipe.

According to an embodiment, the dispenser 20 may be disposed on the door 30. For example, the dispenser 20 may be disposed on the door for opening and closing the freezing chamber. For example, the dispenser 20 may be disposed on the first door 31 for opening and closing the first storage compartment 131.

According to an embodiment, the refrigerator 1 may include an ice maker 60. Ice may be made in the ice maker 60. The dispenser 20 may receive ice from the ice maker 60 and discharge the ice into the water dispensing space. A connection space for moving the ice may be disposed between the ice maker 60 and the dispenser 20. The ice maker 80 may receive water from an external water supply source. The ice maker 60 may receive water directly or indirectly from the water supply pipe 600, for example.

According to an embodiment, the cover member 50 may be disposed above the outer case 11. For example, the cover member 50 may be disposed on the upper surface of the outer case 11. The cover member 50 may be formed by opening a lower side thereof. A portion of the cover member 50 may be disposed to cover a hinge that rotatably couples the door 30 to the main body 10.

According to an example, the cover member 50 may include an upper surface 50a, a front surface 50b extending in a substantially vertical direction from the front edge of the upper surface 50a, and a rear surface 50c extending in a substantially vertical direction from the rear edge of the upper surface 50b. The front surface 50b may be a surface facing substantially in the +x direction. The rear surface 50c may be a surface facing substantially in the −x direction.

According to an embodiment, the cover member 50 may include at least one through hole 51. External air may flow into the cover member 50 through at least one through hole 51. For example, at least one through hole 51 may be positioned on the upper surface 50a of the cover member 50, but is not limited thereto.

According to an embodiment, the cover member 50 may include a hinge cover part 52. The hinge cover part 52 may be a part that covers the hinge of the door 30. The hinge cover part 52 is a portion of the cover member 50 and may be disposed to cover the hinge so that the hinge is not visible from the outside.

According to an embodiment, the refrigerator 1 may include a machine room 40. The machine room 40 may be disposed under the main body, but is not limited thereto. A cold air generating unit may be disposed in the machine room 40. The cold air generating unit may be disposed inside the main body 10 to supply cold air to the storage compartment 20, for example.

According to an example, the cold air generation unit may generate cold air using a cooling circulation cycle that compresses, condenses, expands, and evaporates the refrigerant. For example, a compressor (not shown) that compresses a refrigerant and discharges it in a high-temperature and high-pressure state, a condenser (not shown) that condenses the high-temperature and high-pressure refrigerant compressed by this compressor through heat dissipation, and a condensing fan (not shown) that cools the condenser are disposed in the machine room 40.

FIG. 3 is a view schematically illustrating a PCM steel sheet for home appliances according to an embodiment.

The PCM steel sheet 300 of FIG. 3 may be included in the refrigerator 1 shown in FIGS. 1 and 2. The PCM steel sheet 300 of FIG. 3 may constitute at least a portion of an outer case (e.g., the outer case 11 of FIG. 2) and an inner case (e.g., the inner case 12 of FIG. 2) and a door (e.g., the door 30 of FIG. 2) of the refrigerator 1 of FIGS. 1 and 2.

Referring to FIG. 3, the PCM steel sheet 300 may include a steel sheet 310, a base coating layer 320 disposed on the steel sheet 310, a print layer 330 disposed on the base coating layer 320, a clear coating layer 350 disposed on the print layer 330, and an adhesive layer 340 disposed to adhere the print layer 330 and the clear coating layer 350.

According to an embodiment, the steel sheet 310 may be an electro-galvanized iron (EGI) steel sheet or a galvanized iron (GI) steel sheet. However, the disclosure is not limited thereto, and the type of steel sheet may vary depending on the purpose and function. For example, various types of steel sheets such as stainless steel and cold rolled steel sheets may be applied to the steel sheet 310.

According to an embodiment, the base coating layer 320 may be formed of a polyester (PE) resin as a main raw material. The base coating layer 320 may include a melamine curing agent, an isocyanate curing agent, and a matting agent for adjusting surface tension. Various colors and patterns may be applied on the base coating layer 320.

Table 1 below exemplarily shows a composition ratio of some of the materials constituting the base coating layer 320. The unit of each component is wt %.

Various materials may be added to the base coating layer 320 in addition to the materials shown in Table 1.

TABLE 1

| | embodiment | embodiment | embodiment |
|---|---|---|---|
| components | 1-1 | 1-2 | 1-3 |
| polyester (PE) resin | 58 to 78 | 60 to 75 | 60 to 75 |
| melamine | 1 to 5 | 0 | 1 to 3 |
| isocyanate | 0 | 1 to 5 | 1 to 3 |
| matting agent | 0 to 10 | 0 to 10 | 0 to 10 |

As described in Table 1, the base coating layer 320 may have the composition of one of embodiment 1-1, embodiment 1-2, or embodiment 1-3, but this is exemplary, and the composition ratio of the base coating layer 320 is not limited thereto.

According to an embodiment, the base coating layer 320 may include up to 10 wt % of the matting agent based on the total weight of the base coating layer 320.

According to an embodiment, the base coating layer 320 may include at least one of a melamine curing agent or an isocyanate curing agent.

According to an embodiment, the base coating layer 320 may include 1 wt % to 20 wt % of the melamine curing agent based on the total weight of the base coating layer 320. For example, the base coating layer 320 may include 1 wt % to 5 wt % of melamine curing agent based on the total weight of the base coating layer 320 as in embodiment 1-1.

According to an embodiment, the base coating layer 320 may include 1 wt % to 20 wt % of the isocyanate curing agent based on the total weight of the base coating layer 320. For example, the base coating layer 320 may include 1 wt % to 5 wt % of the isocyanate curing agent based on the total weight of the base coating layer 320 as in embodiment 1-2. For example, the base coating layer 320 may include 1 wt % to 3 wt % of the melamine curing agent and 1 wt % to 3 wt % of the isocyanate curing agent based on the total weight of the base coating layer 320 as in embodiment 1-3.

According to an embodiment, the base coating layer 320 may include at least one of an epoxy resin, a defoamer, a catalyst, an adhesion promoter, and an organic solvent. For example, the base coating layer 320 of embodiment 1-1, embodiment 1-2, or embodiment 1-3 of Table 1 may include at least one of an epoxy resin, a defoamer, a catalyst, an adhesion promoter, and an organic solvent. For example, the base coating layer 320 may include up to 3.0 wt % of epoxy resin based on the total weight of the base coating layer 320. For example, the base coating layer 320 may include 0.5 wt % to 1.0 wt % of defoamer based on the total weight of the base coating layer 320. For example, the base coating layer 320 may be strongly adhered to the steel sheet 310 by including up to 1.0 wt % of adhesion promoter based on the total weight of the base coating layer 320. For example, the base coating layer 320 may include 20 wt % to 30 wt % of organic solvent based on the total weight of the base coating layer 320.

According to an embodiment, the print layer 330 may be adhered to the base coating layer 320 to maintain the printed color and pattern. The clear coating layer 350 is disposed on the print layer 330 so that the clear coating layer 350 may clearly maintain the color and pattern printed on the print layer 330.

According to an embodiment, the print layer 330 may be formed by a digital printing method. The digital printing method may directly print a high-resolution digital image on the steel sheet, and have a simplified process compared to a printing method using gravure roll, which is a conventional printing method. Further, the digital printing method may accurately reproduce complex patterns, images and/or text, and may be customized for various designs, which may be advantageous for small-scale production. The digital printing method may provide fast curing speed and excellent durability using ink such as, e.g., UV curing ink. The print layer 330 formed by the digital printing method may maintain a printed design for a long time by a strong adhesive force to the base coating layer 320.

According to an embodiment, the clear coating layer 350 may enhance aesthetics by imparting gloss to the surface. The clear coating layer 350 may be disposed to prevent damage to the print layer 330 from the outside. For example, the clear coating layer 350 may be disposed to protect the steel sheet 310 and the print layer 330 from external environments such as physical damage, chemical corrosion, or ultraviolet rays. For example, the clear coating layer 350 may be a PET film layer.

According to an embodiment, the clear coating layer 350 may be formed using a polyester (PE) resin as a main raw material. According to an embodiment, the clear coating layer 350 may include acrylic and/or urethane.

Table 2 below exemplarily shows a composition ratio of some of the materials constituting the clear coating layer 350. The unit of each component is wt %.

Various materials may be added to the clear coating layer 350 in addition to the materials shown in Table 2.

TABLE 2

| | embodi- | embodi- | embodi- | embodi- | embodi- | embodi- |
|---|---|---|---|---|---|---|
| | ment | ment | ment | ment | ment | ment |
| components | 2-1 | 2-2 | 2-3 | 2-4 | 2-5 | 2-6 |
| polyester | 60 to 75 | 60 | 35 to 40 | 60 | 35 to 40 | 60 to 75 |
| resin | | | | | | |
| acrylic | 0 | 0 | 5 to 10 | 10 to 15 | 10 to 15 | 0 |
| urethane | 0 | 0 | 0 | 0 | 5 to 10 | 10 to 15 |

As shown in Table 2, the clear coating layer 350 may have the composition of one of embodiment 2-1, 2-2, 2-3, 2-4, 2-5, or 2-6, but is exemplary, and the composition ratio of the clear coating layer 350 is not limited thereto.

According to an embodiment, the clear coating layer 350 may include at least one of melamine, a leveling agent, a defoamer, a catalyst, an adhesion promoter, a wetting agent, and an organic solvent. For example, the clear coating layer 350 of embodiment 2-1, embodiment 2-2, embodiment 2-3, embodiment 2-4, embodiment 2-5, or embodiment 2-5 of Table 2 may include at least one of melamine, a leveling agent, a defoamer, a catalyst, a wetting agent, and an organic solvent. For example, the clear coating layer 350 may include up to 20 wt % of melamine based on the total weight of the clear coating layer 350. For example, the clear coating layer 350 may include 1.0 wt % to 2.0 wt % of leveling agent based on the total weight of the clear coating layer 350. For example, the clear coating layer 350 may include 0.2 wt % to 0.5 wt % of defoamer based on the total weight of the clear coating layer 350. For example, the clear coating layer 350 may be strongly adhered to the steel sheet 310 by including 0.5 wt % to 1.0 wt % of adhesion promoter based on the total weight of the clear coating layer 350. For example, the clear coating layer 350 may include 1.0 wt % to 2.0 wt % of wetting agent based on the total weight of the clear coating layer 350. For example, the clear coating layer 350 may include 15 wt % to 20 wt % of organic solvent based on the total weight of the clear coating layer 350.

According to an embodiment, the adhesive layer 340 may include an adhesive that is rapidly cured through ultraviolet curing, but is not limited thereto. The adhesive layer 340 may be omitted from the configuration of the PCM steel sheet 300.

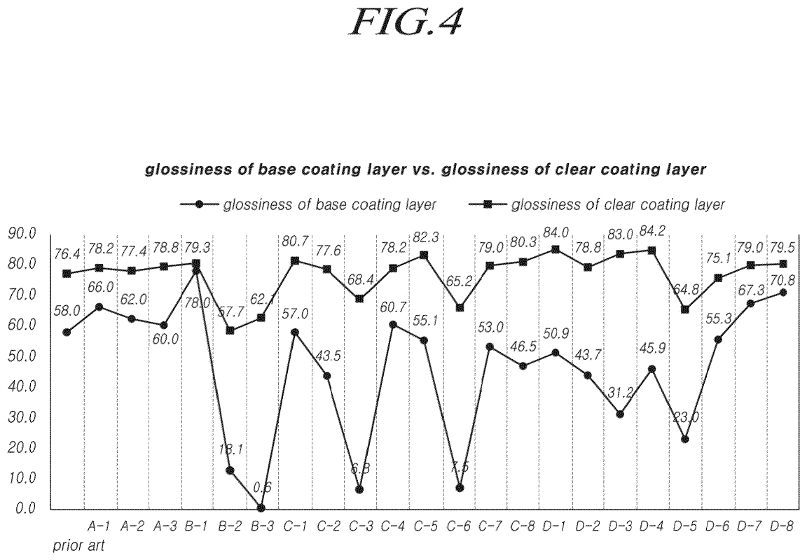

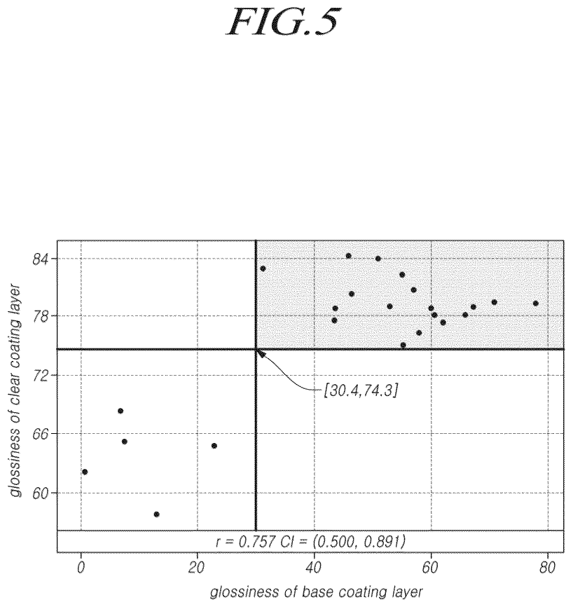

FIGS. 4 and 5 are graphs illustrating the relationship between the glossiness of a base coating layer and the glossiness of a clear coating layer in the PCM steel sheet of FIG. 3.

Table 3 is an experimental table comparing the glossiness of the base coating layer and the glossiness of the clear coating layer while changing the surface tension and curing degree with respect to the specifications of the base coating layer 320.

Here, as the glossiness, the amount of reflected light when light is incident on the surface at an angle of 20 degrees is measured using a gloss meter.

The graphs of FIG. 4 and FIG. 5 are graphs showing the correlation between the glossiness of the base coating layer and the glossiness of the clear coating layer, which are the experimental result values of Table 3. The vertical axis of FIG. 4 represents the glossiness. The horizontal axis of FIG. 5 represents the glossiness of the base coated layer, and the vertical axis represents the glossiness of the clear coated layer.

TABLE 3

| | surface | curing | glossiness (GU) | glossiness (GU) |
|---|---|---|---|---|
| | tension | degree | of base coating | of clear coating |
| No. | (dyne) | (MEK) | layer | layer |
| prior | 30 | 37 | 58.0 | 76.4 |
| art | | | | |
| A-1 | 30 | 50 | 66.0 | 78.2 |
| A-2 | 30 | 40 | 62.0 | 77.4 |
| A-3 | 30 | 45 | 60.0 | 78.8 |
| B-1 | 28 | 35 | 78.0 | 79.3 |
| B-2 | 60 | 25 | 13.1 | 57.7 |
| B-3 | 60 | 0 | 0.6 | 62.1 |
| C-1 | 30 | 20 | 57.0 | 80.7 |
| C-2 | 30 | 5 | 43.5 | 77.6 |
| C-3 | 30 | 1 to 2 | 6.8 | 68.4 |
| C-4 | 30 | 23 | 60.7 | 78.2 |
| C-5 | 30 | 31 | 55.1 | 82.3 |
| C-6 | 32 | 2 | 7.5 | 65.2 |
| C-7 | 30 | 16 | 53.0 | 79.0 |
| C-8 | 30 | 19 | 46.5 | 80.3 |
| D-1 | 30 | 55 | 50.9 | 84.0 |
| D-2 | 30 | 58 | 43.7 | 78.8 |
| D-3 | 30 | 43 | 31.2 | 83.0 |
| D-4 | 30 | 17 | 45.9 | 84.2 |
| D-5 | 30 | 15 | 23.0 | 64.8 |
| D-6 | 30 | 19 | 55.3 | 75.1 |
| D-7 | 30 | 47 | 67.3 | 79.0 |
| D-8 | 30 | 100 | 70.8 | 79.5 |

Referring to FIGS. 4 and 5, it may be identified that the glossiness of the clear coating layer 350 is affected by the composition of the paint of the base coating layer 320. Since the image is printed on the base coating layer 320 using a digital printing method, the distinctness of image of the image may vary depending on the physical properties of the base coating layer 320, and the clear coating layer 350 on the print layer 330 on which the image is printed may also be affected, resulting in a different glossiness.

As a result of comparing the glossiness of the clear coating layer 350 according to the glossiness of the base coating layer 320 as shown in FIG. 5 based on the test example shown in Table 3, the correlation was identified through an experiment that when the glossiness of the base coating layer 320 was 30 or more, the glossiness of the clear coating layer might be 70 or more. For example, as illustrated, when the glossiness of the base coating layer 320 is 30.4 or more, the glossiness of the clear coating layer 350 may be 74.3 or more.

According to an embodiment, the PCM steel sheet 300 according to an embodiment may be manufactured so that the glossiness of the base coating layer 320 is 30 GU or more, thereby designing the clear coating layer 350 (or the surface of the PCM steel sheet 300) to have a glossiness of 70 GU or more.

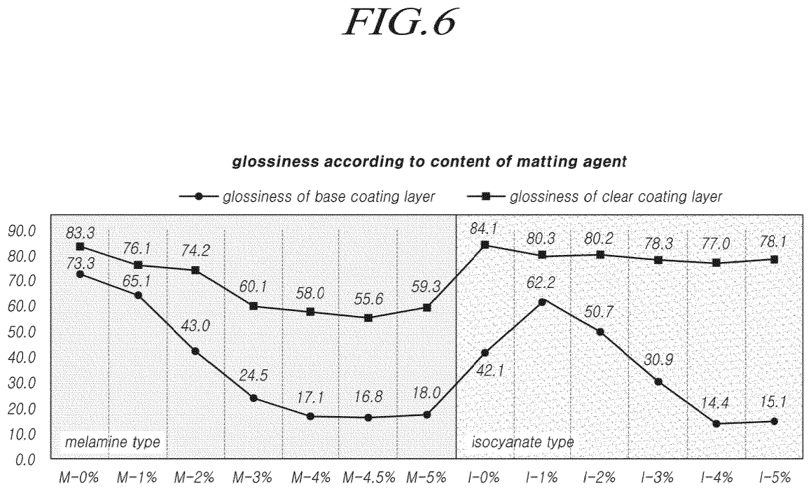

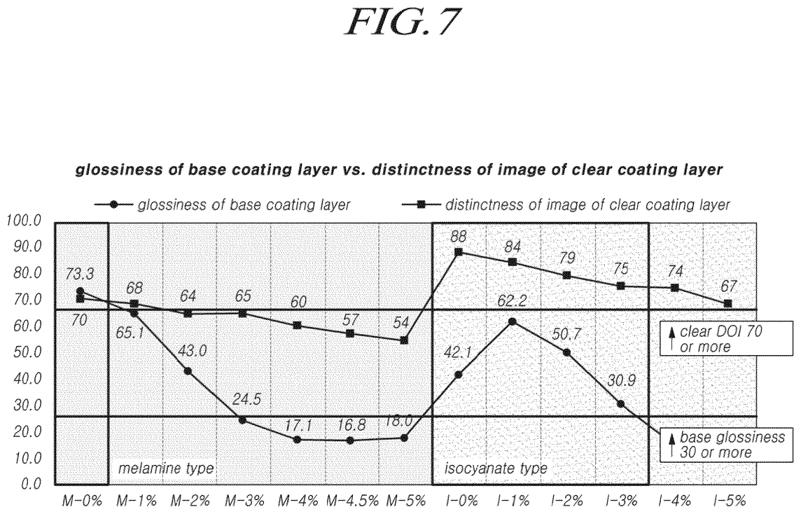

FIGS. 6 and 7 are graphs illustrating the glossiness and distinctness of image (DOI) of a clear coating layer according to the type of a curing agent and a proportion of a matting agent added in the PCM steel sheet of FIG. 3.

FIGS. 6 and 7 are graphs measuring the glossiness and distinctness of image of the clear coating layer 350 (or the surface of the PCM steel sheet 300) by adjusting the type of the curing agent and the weight ratio of the matting agent (or the surface tension modifier) among the materials included in the base coating layer 320. FIG. 6 is a graph that shows the relationship between the glossiness of the base coating layer 320 and the glossiness of the clear coating layer 350 according to the type of curing agent included in the base coating layer 320 and the content of the matting agent. FIG. 7 is a graph that shows the relationship between the glossiness of the base coating layer 320 and the distinctness of image of the clear coating layer 350 according to the type of curing agent included in the base coating layer 320 and the content of the matting agent.

In FIGS. 6 and 7, the horizontal axis may denote the trial. M-0% used the base coating layer 320 including the melamine curing agent and 0 wt % of matting agent, M-1% used the base coating layer 320 including the melamine curing agent and 1 wt % of matting agent, M-2% used the base coating layer 320 including the melamine curing agent and 2 wt % of matting agent, M-3% used the base coating layer 320 including the melamine curing agent and 3 wt % of matting agent, M-4% used the base coating layer 320 including the melamine curing agent and 4 wt % of matting agent, M-4.5% used the base coating layer 320 including the melamine curing agent and 4.5 wt % of matting agent, M-5% used the base coating layer 320 including the melamine curing agent and 5 wt % of matting agent, I-0% used the base coating layer 320 including the isocyanate curing agent and 0 wt % of matting agent, I-1% used the base coating layer 320 including the isocyanate curing agent and 1 wt % of matting agent, I-2% used the base coating layer 320 including the isocyanate curing agent and 2 wt % of matting agent, I-3% used the base coating layer 320 including the isocyanate curing agent and 3 wt % matting agent, I-4% used the base coating layer 320 including the isocyanate curing agent and 4 wt % of matting agent, and I-5% used the isocyanate curing agent and 5 wt % of matting agent.

In FIGS. 6 and 7, the vertical axis may denote the glossiness or distinctness of image (DOI).

Here, as the glossiness, the amount of reflected light when light is incident on the surface at an angle of 20 degrees is measured using a gloss meter.

Here, the distinctness of image is expressed as a value between 0 and 100, and the larger the value, the higher the distinctness of image of the image.

Here, the glossiness and distinctness of image of the clear coating layer 350 may be the glossiness and distinctness of image of the PCM steel sheet 300 for home appliances.

Table 4 shows values obtained by measuring the glossiness and distinctness of image of the clear coating layer 350 (or the surface of the PCM steel sheet 300) by adjusting the type of curing agent and the weight ratio of the matting agent among the materials included in the base coating layer 320.

In Table 4, the melamine curing agent was used for the base coating layer 320 for trials 1 to 7, and the isocyanate curing agent was used for the base coating layer 320 for trials 8 to 13.

Trials 1 to 7 sequentially increased the matting agent content to 0% to 5% in a state in which a melamine curing agent was used in the base coating layer 320. In trials 1 to 7, the base coating layer 320 of embodiment 1-1 may be used as the base coating layer 320, but the disclosure is not limited thereto.

Trial 8 to 13 sequentially increased the matting agent content to 0% to 5% in a state in which an isocyanate curing agent was used for the base coating layer 320. In trials 8 to 13, the base coating layer 320 of embodiments 1-2 may be used as the base coating layer 320, but is not limited thereto.

The clear coating layer 350 used in trials 1 to 13 may be the clear coating layer 350 of embodiment 2-1, 2-2, 2-3, 2-4, 2-5, or 2-6, but is not limited thereto. For example, the clear coating layer 350 of embodiment 2-4 may be used to enhance the glossiness and distinctness of image of the clear coating layer 350.

TABLE 4

| | | | | glossiness | glossiness | |
|---|---|---|---|---|---|---|
| | | content | | of base | of clear | DOI of |
| | type of | of | surface | coating | coating | clear |
| | curing | matting | tension | layer | layer | coating |
| trial | agent | agent | (dyne) | (GU) | (GU) | layer |
| 1 | melamine | 0% | 30 | 73.3 | 83.3 | 70 |
| 2 | | 1% | 32 | 65.1 | 76.1 | 68 |
| 3 | | 2% | 32 | 43.0 | 74.2 | 64 |
| 4 | | 3% | 34 | 24.5 | 60.1 | 65 |
| 5 | | 4% | 38 | 17.1 | 58.0 | 60 |
| 6 | | 4.5% | 44 | 16.8 | 55.6 | 57 |
| 7 | | 5% | 60 | 18.0 | 59.3 | 54 |
| 8 | isocyanate | 0% | 30 | 42.1 | 84.1 | 88 |
| 9 | | 1% | 30 | 62.2 | 80.3 | 84 |
| 10 | | 2% | 30 | 50.7 | 80.2 | 79 |
| 11 | | 3% | 32 | 30.9 | 78.3 | 75 |
| 12 | | 4% | 40 | 14.4 | 77.0 | 74 |
| 13 | | 5% | 60 | 15.1 | 78.1 | 67 |

To impart as high a glossiness and distinctness of image as the VCM steel sheet to the PCM steel sheet 300 having an image printed thereon using a digital printing method, the distinctness of image (DOI) of the clear coating layer 350 of the PCM steel sheet 300 needs to be 70 or more.

Referring to the experimental values of Table 4, it may be identified that the distinctness of image of the clear coating layer 350 is 70 or more only when the content of the matting agent is 0 wt % when the base coating layer 320 includes the melamine curing agent. Further, when the base coating layer 320 includes an isocyanate curing agent, it may be identified that the distinctness of image of the clear coating layer 350 is 70 or more when the matting agent content is 0 wt % to 4 wt %. If the content of the matting agent exceeds 4 wt % in a 10 state in which the base coating layer 320 includes the isocyanate curing agent, the distinctness of image of the clear coating layer 350 may fall below 70, thereby deteriorating the aesthetics of the PCM steel sheet 300.

According to an embodiment, the base coating layer 320 included in the PCM steel sheet 300 having a high glossiness and high distinctness of image may include a melamine curing agent and a 0 wt % of matting agent. When the base coating layer 320 includes a melamine curing agent, if a matting agent is added, the distinctness of image of the clear coating layer 350 may be reduced to less than 70. The melamine curing agent may produce water by a condensation reaction during the reaction, thereby affecting the printing of the print layer 330, and affecting the surface state of the clear coating layer 350 such as a decrease in glossiness or distinctness of image.

According to an embodiment, the base coating layer 320 included in the PCM steel sheet 300 having a high glossiness and high distinctness of image may include an isocyanate curing agent and up to 4 wt % of matting agent. When the base coating layer 320 includes an isocyanate curing agent, if the matting agent content exceeds 4 wt %, the distinctness of image of the clear coating layer 350 may be reduced to less than 70.

According to an embodiment, the glossiness of the base coating layer 320 included in the PCM steel sheet 300 having a high gloss and high distinctness of image may be 30 GU or more. Referring to the experimental values in Table 4, it may be identified that the distinctness of image of the clear coating layer 350 is 70 or more when the glossiness of the base coating layer 320 is 30 GU or more. Therefore, in order to have a high glossiness and high distinctness of image, the glossiness of the base coating layer 320 may be 30 GU or more.

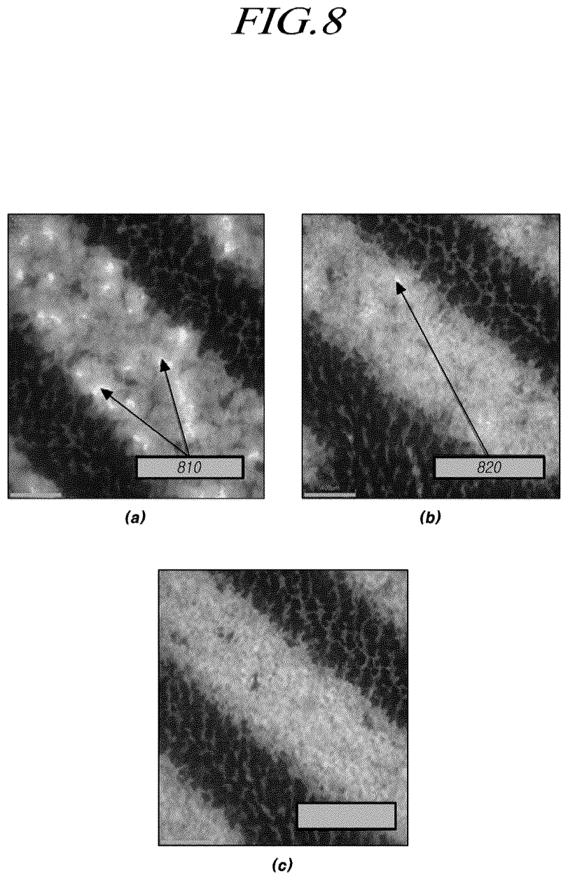

FIG. 8 illustrates an experimental example for describing the distinctness of image of a print layer according to a proportion of a matting agent added to a base coating layer in the PCM steel sheet of FIG. 3.

FIG. 8(a) is an experimental result of printing an image on the upper surface without adding a matting agent to the base coating layer 320, FIG. 8(b) is an experimental result of printing an image on the upper surface with a digital printing method with 2 wt % of matting agent added to the base coating layer 320, and FIG. 8(c) is an experimental result of printing an image on the upper surface with a digital printing method with 4 wt % of matting agent added to the base coating layer 320.

FIG. 8(a), FIG. 8(b), and FIG. 8(c) are experimental examples, and the scope of the disclosure is not limited thereto.

The distinctness of image of the print layer 330 printed on the base coating layer 320 by a digital printing method may be affected by the surface tension of the base coating layer 320. When the surface tension of the ink used for digital printing is excessively smaller than the surface tension of the base coating layer 320, the image to be printed may be blurred as the ink spreads, and distinctness of image may be deteriorated. When the surface tension of the ink used for digital printing is excessively larger than the surface tension of the base coating layer 320, the ink may be aggregated to generate craters (e.g., 810 and 820). Here, the crater may refer to a portion where the ink is aggregated to expose the surface of the base coating layer 320 to the outside. Therefore, it is necessary to add an appropriate amount of matting agent (or surface tension modifier) to the base coating layer 320 to minimize crater formation and enhance distinctness of image.

According to an embodiment, as shown in FIG. 8(a), when the matting agent is not added to the surface of the base coating layer 320, a plurality of craters 810 may be formed between printed images.

According to an embodiment, as shown in FIG. 8(b), when 2 wt % of the matting agent is added to the surface of the base coating layer 320, a relatively small number of craters 820 may be formed as compared with FIG. 8(a).

According to an embodiment, as shown in FIG. 8(c), when 4 wt % of the matting agent is added to the surface of the base coating layer 320, no crater may be formed as ink used for digital printing appropriately spreads.

When the matting agent in excess of 4 wt % is added to the surface of the base coating layer 320, the image to be printed may be blurred due to the spread of ink, deteriorating the distinctness of image. Therefore, the content of the matting agent added to the base coating layer 320 to enhance distinctness of image may be up to 4 wt % based on the total weight of the base coating layer 320. For example, the content of the matting agent added to the base coating layer 320 may be more than 2 wt %, and less than or equal to 4 wt % based on the total weight of the base coating layer 320.

According to an embodiment, the surface tension of the base coating layer 320 may be 30 dynes to 60 dynes in order to minimize the formation of the craters (e.g., 810 and 820) and to minimize blur of the image to be printed by a digital printing method.

The PCM steel sheet 300 according to an embodiment of the disclosure may secure printability of digital printing by adjusting the composition and properties of the base coating layer 320, thereby obtaining a high-quality exterior design.

The PCM steel sheet 300 according to an embodiment of the disclosure may be capable of printing all colors and patterns at once by a digital printing method, thus eliminating the need for as many silkscreens or gravure printing rolls as the colors and patterns, and saving manufacturing time and costs.

The PCM steel sheet 300 according to an embodiment of the disclosure prints may include a base coating layer 320 appropriate for a digital printing method to enhance the overall glossiness and distinctness of image by printing colors and patterns using a digital printing method.

A PCM steel sheet for home appliances according to an embodiment may comprise a steel sheet 310, a base coating layer 320 disposed on the steel sheet 310 and including at least one of a melamine curing agent and an isocyanate curing agent, a print layer 330 disposed on the base coating layer 320, and a clear coating layer 350 disposed on the print layer 330. The base coating layer 320 may include up to 10 wt % of matting agent based on the total weight of the base coating layer 320.

According to an embodiment, the base coating layer 320 may include 1 wt % to 5 wt % of the melamine curing agent based on the total weight of the base coating layer 320.

According to an embodiment, the base coating layer 320 may include 1 wt % to 5 wt % of the isocyanate curing agent based on the total weight of the base coating layer 320.

According to an embodiment, the base coating layer 320 may include 1 wt % to 3 wt % of the melamine curing agent and 1 wt % to 3 wt % of the isocyanate curing agent based on the total weight of the base coating layer 320.

According to an embodiment, a surface tension of the base coating layer 320 may be 30 dynes to 60 dynes.

According to an embodiment, the base coating layer 320 may include up to 4 wt % of matting agent based on the total weight of the base coating layer 320.

According to an embodiment, the print layer 330 may be printed by using a digital printing method.

According to an embodiment, a 20-degree gloss of the base coating layer 320 may be 30 GU or more.

According to an embodiment, a 20-degree gloss of the clear coating layer 350 affected by the 20-degree gloss of the base coating layer 320 may be 70 GU or more.

According to an embodiment, a distinctness of image (DOI) of the clear coating layer 350 affected by the 20-degree gloss of the base coating layer 320 may be 70 or more.

A refrigerator according to an embodiment may comprise a main body 10, a storage compartment 13 disposed inside the main body 10, and a door 30 coupled to the main body 10 to open at least a portion of the storage compartment 13. The door 30 may include a PCM steel sheet 300. The PCM steel sheet for home appliances may comprise a steel sheet 310, a base coating layer 320 disposed on the steel sheet 310 and including at least one of a melamine curing agent and an isocyanate curing agent, a print layer 330 disposed on the base coating layer 320, and a clear coating layer 350 disposed on the print layer 330. The base coating layer 320 may include up to 10 wt % of matting agent based on the total weight of the base coating layer 320.

According to an embodiment, the base coating layer 320 may include 1 wt % to 20 wt % of the melamine curing agent based on the total weight of the base coating layer 320. For example, the base coating layer 320 may include 1 wt % to 5 wt % of the melamine curing agent based on the total weight of the base coating layer 320.

According to an embodiment, the base coating layer 320 may include 1 wt % to 20 wt % of the isocyanate curing agent based on the total weight of the base coating layer 320. For example, the base coating layer 320 may include 1 wt % to 5 wt % of the isocyanate curing agent based on the total weight of the base coating layer 320.

According to an embodiment, the base coating layer 320 may include 1 wt % to 3 wt % of the melamine curing agent and 1 wt % to 3 wt % of the isocyanate curing agent based on the total weight of the base coating layer 320.

According to an embodiment, a surface tension of the base coating layer 320 may be 30 dynes to 60 dynes.

According to an embodiment, the base coating layer 320 may include up to 4 wt % of matting agent based on the total weight of the base coating layer 320.

According to an embodiment, the print layer 330 may be printed by using a digital printing method.

According to an embodiment, a 20-degree gloss of the base coating layer 320 may be 30 GU or more.

According to an embodiment, a 20-degree gloss of the clear coating layer 350 affected by the 20-degree gloss of the base coating layer 320 may be 70 GU or more.

According to an embodiment, a distinctness of image (DOI) of the clear coating layer 350 affected by the 20-degree gloss of the base coating layer 320 may be 70 or more.

In the disclosure, the above-described description has been made mainly of specific embodiments, but the disclosure is not limited to such specific embodiments, but should rather be appreciated as covering all various modifications, equivalents, and/or substitutes of various embodiments.

What is claimed is:

1. A pre-coated metal (PCM) steel sheet for a home appliance comprising:
a steel sheet;
a base coating layer on the steel sheet, the base coating layer including a matting agent and at least one of a melamine curing agent and an isocyanate curing agent;
a print layer on the base coating layer; and
a clear coating layer on the print layer,
wherein the base coating layer includes up to 10 wt % of the matting agent based on a total weight of the base coating layer.

2. The PCM steel sheet of claim 1, wherein the base coating layer includes 1 wt % to 20 wt % of the melamine curing agent based on the total weight of the base coating layer.

3. The PCM steel sheet of claim 1, wherein the base coating layer includes 1 wt % to 20 wt % of the isocyanate curing agent based on the total weight of the base coating layer.

4. The PCM steel sheet of claim 1, wherein the base coating layer includes 1 wt % to 3 wt % of the melamine curing agent based on the total weight of the base coating layer and 1 wt % to 3 wt % of the isocyanate curing agent based on the total weight of the base coating layer.

5. The PCM steel sheet of claim 1, wherein a surface tension of the base coating layer is 30 dynes to 60 dynes.

6. The PCM steel sheet of claim 1, wherein the base coating layer includes up to 4 wt % of the matting agent based on the total weight of the base coating layer.

7. The PCM steel sheet of claim 1, wherein the print layer is printed on the base coating layer based on a digital image.

8. The PCM steel sheet of claim 1, wherein a 20-degree gloss of the base coating layer is 30 GU or more.

9. The PCM steel sheet of claim 8, wherein a 20-degree gloss of the clear coating layer is 70 GU or more.

10. The PCM steel sheet of claim 8, wherein a distinctness of image (DOI) of the clear coating layer is 70 or more.

11. A refrigerator, comprising:
a main body;
a storage compartment formed inside the main body; and
a door rotatably coupled to the main body and configured to open at least a portion of the storage compartment, the door including a pre-coated metal (PCM) steel sheet including:
a steel sheet,
a base coating layer on the steel sheet, the base coating layer including a matting agent and at least one of a melamine curing agent and an isocyanate curing agent,
a print layer on the base coating layer, and
a clear coating layer on the print layer,
wherein the base coating layer includes up to 10 wt % of the matting agent based on a total weight of the base coating layer.

12. The refrigerator of claim 11, wherein the base coating layer includes 1 wt % to 20 wt % of the melamine curing agent based on the total weight of the base coating layer.

13. The refrigerator of claim 11, wherein the base coating layer includes 1 wt % to 20 wt % of the isocyanate curing agent based on the total weight of the base coating layer.

14. The refrigerator of claim 11, wherein the base coating layer includes 1 wt % to 3 wt % of the melamine curing agent based on the total weight of the base coating layer and 1 wt % to 3 wt % of the isocyanate curing agent based on the total weight of the base coating layer.

15. The refrigerator of claim 11, wherein a surface tension of the base coating layer is 30 dynes to 60 dynes.

16. The refrigerator of claim 11, wherein the base coating layer includes up to 4 wt % of matting agent based on the total weight of the base coating layer.

17. The refrigerator of claim 11, wherein the print layer is printed on the base coating layer based on a digital image.

18. The refrigerator of claim 11, wherein a 20-degree gloss of the base coating layer is 30 GU or more.

19. The refrigerator of claim 18, wherein a 20-degree gloss of the clear coating layer is 70 GU or more.

20. The refrigerator of claim 18, wherein a distinctness of image (DOI) of the clear coating layer is 70 or more.
